(19) United States
(12) Patent Application Publication
(10) Pub. No.: US 2008/0299448 A1
(43) Pub. Date: Dec. 4, 2008

(54) BATTERY UNIT WITH TEMPERATURE CONTROL DEVICE

(76) Inventors: Derrick Scott Buck, Pendleton, IN (US); Paul Leslie Kemper, Frankton, IN (US); Bruce James Silk, Boca Raton, FL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/934,153

(22) Filed: Nov. 2, 2007

Related U.S. Application Data
(60) Provisional application No. 60/860,034, filed on Nov. 20, 2006.

(51) Int. Cl. H01M 10/50; B23P 15/26

(52) U.S. Cl. 429/120; 29/890.035

(57) ABSTRACT

A battery unit (10) includes a plurality of trays (14) connected to one another and positioned on top of one another to define sides (16, 18, 20, 22) and top (24) and a bottom of the battery unit (10). A plurality of cells (12) are adjacent one and the other and connected with one another in overlapping relationship with each of the cells (12) extending over spaced openings (50) defined in the trays (14). A controller (54) is connected to the tray operably communicating with each of the cells (12).

### RELATED APPLICATIONS

This non-provisional application claims priority to a provisional application Ser. No. 60/860,034 filed on Nov. 20, 2006 and incorporated herewith by reference in its entirety.

### FIELD OF THE INVENTION

The subject invention relates to battery packs having cells and more particularly, to a battery pack for electric/hybrid vehicles having a cooling system for providing a uniform cooling of the cells within the battery pack.

### BACKGROUND OF THE INVENTION

Motor vehicles, such as, for example, hybrid vehicles use multiple propulsion systems to provide motive power. This most commonly refers to gasoline-electric hybrid vehicles, which use gasoline (petrol) to power internal-combustion engines (ICEs), and electric batteries to power electric motors. These hybrid vehicles recharge their batteries by capturing kinetic energy via regenerative braking. When cruising or idling, some of the output of the combustion engine is fed to a generator (merely the electric motor(s) running in generator mode), which produces electricity to charge the batteries. This contrasts with all-electric cars which use batteries charged by an external source such as the grid, or a range extending trailer. Nearly all hybrid vehicles still require gasoline as their sole fuel source though diesel and other fuels such as ethanol or plant based oils have also seen occasional use.

Batteries and cells are important energy storage devices well known in the art. The batteries and cells typically comprise electrodes and an ion conducting electrolyte positioned therebetween. It is well known in the art of electric/hybrid vehicles to provide a high voltage battery pack that includes a number of individual cells to provide the necessary energy to drive the vehicle. When such a battery pack is charged or discharged, heat is produced which, if uncontrolled, can have a significant impact on the life and performance of the battery pack as a whole as well as the individual cells that form the battery pack.

The high voltage battery packs are adaptable to receive and deliver high and fast rates of current (C-rate). It is also critical to maintain the temperature of the battery packs within a defined operating range to maximize the performance and life span of the battery pack. To maintain the batteries formed by the cells at a desired temperature, a temperature control system is provided within the battery pack for passing cool or hot air only over the external surfaces of the battery packs, wherein the cool air picks up heat from and between the cells and loses its cooling capacity, thereby creating cooler battery temperatures near the inlet and hotter temperatures near the outlet. As a result, significant temperature variances can occur from one battery cell to the adjacent battery cell, thereby detrimentally impacting the performance and life span of the battery pack.

Conventionally, as will be discussed furtherbelow, various other prior art cooling systems pass cool air only over the external surfaces of the batteries. Thus, the air picks up heat from battery to battery and loses its cooling capacity. This arrangement inherently creates cooler battery temperatures near the inlet and hotter temperatures near the outlet. Another drawback associated with the conventional systems relates to the airflow being uncontrolled thereby resulting in unbalanced airflow wherein air does not flow past each cell at the same rate and same temperature.

As a result, significant temperature variances can occur from one cell to the next, which is detrimental to performance of the battery pack. In order for the batteries to be properly charged, the cells must be below a desired threshold temperature and the differential temperature between the cells in the battery pack should be minimized. However, depending on the thermal path to ambient, different cells will reach different temperatures. Further, for the same reasons, different cells reach different temperatures during the charging process. Accordingly, if one cell is at an increased temperature with respect to the other cells, its charge or discharge efficiency will be different, and, therefore, it may charge or discharge faster than the other cells. This will lead to a decline in the performance of the entire pack.

The art is replete with various designs of battery packs with cooling systems. The U.S. Pat. No. 5,932,365 to Lin et al. teaches a hydrogen canister fuel cell battery having a base having at least one hydrogen distribution channel communicating with a hydrogen canister for passing of hydrogen into a fuel pack formed from multiple cells and disposed on the base. An air supply such as a fan is disposed in front of the fuel pack for sending air into the fuel pack, where oxygen and hydrogen will generate electricity by electrochemical reaction. The components of the fuel cell pack are arranged in reverse order to define hydrogen and oxygen pathways. The battery and method of cooling the cells taught by the U.S. Pat. No. 5,932,365 to Lin et al., to extend being effective, may result in significant temperature variances, which occur from one cell to the adjacent cell, thereby detrimentally impacting the performance and life span of the battery.

The U.S. Pat. No. 7,014,945 to Moores, Jr. et al. teaches a power tool having a battery pack with a plurality of cells. A housing of the battery pack with a venting system which enables fluid to pass around the battery cells. The ventilation system includes at least one inlet and at least one outlet. A fan moves fluid through the battery pack inlet. The fluid is forced over the battery cells and out the outlets. Thus, a positive pressure is created in the battery pack as fluid flows through the battery pack. A side channel directs the fluid through the battery cells so that the fluid does not continue to pass from cell to cell but passes over different cells so that the cells experience the air at about the same temperature. As a result, significant temperature variances can occur from one battery cell to the adjacent battery cell, thereby detrimentally impacting the performance and life span of the battery pack.

The U.S. Pat. No. 6,569,556 to Zhou et al., for example, teaches a battery pack for an electric/hybrid vehicle including a cooling system that provides cooling of the batteries within the pack. The battery pack includes a base that supports the batteries stacked vertically in layers one atop the other. Each battery includes a plurality of cells with cooling air channels between them. A retention frame overlays and is affixed to the batteries to restrict the movement of the batteries within the pack. The batteries are held in spacers disposed above and below each layer of batteries. The spacers provide air passages above and below the batteries to allow cool air to flow across the batteries and through the cooling channels. An inlet admits cool air into the pack and an outlet releases the air from the pack after it is has passed through the stack of batteries. A front manifold is connected to the inlet and includes a plurality of separate runners for splitting the air between the spacers below each layer of batteries. A back manifold directs air from the spacers above each layer of batteries toward the outlet of the pack. The cooling system taught by the U.S. Pat. No. 6,569,556 to Zhou et al. is limited to a configuration of the cells stacked vertically relative to the spacers and the retention frame and do not provide balanced air management system and require a multitude of structural elements which is not cost effective.

The United States Patent Application No. 20030124419 to Ito et al., teaches an assembled battery having laminated batteries extending either along a single row or a plurality of parallel rows, terminals, rugged portions, air blowing means, heat insulators and bus bars. The terminals take out an output of the laminated batteries. The rugged portions are provided on surfaces or in internal portions of the bus bars. The air blowing means blows cooling air to the laminated batteries, thereby cooling surfaces of the laminated batteries. The heat insulators absorb the heat radiated from the laminated batteries and prevent the heat from being discharged to the outside of the assembled battery. The rugged portions are provided on the surfaces of the bus bars opposing to the heat insulators. The laminated batteries are continuously connected to one another wherein the bus bars are extending along terminal ends of the batteries, as the batteries extend along the single row, or between the batteries, as the batteries extend along parallel rows. The cooling system taught by the United States Patent Application No. 20030124419 to Ito et al. does not provide balanced air management system and fails to provide a cooling system for evenly cooling of the batteries.

As such, there is a constant need in the area of a battery art for an improved design of a battery pack that provides an even cooling of the battery packs with balanced air management cooling system wherein each cell receives a similar temperature and flow of inlet air to remove the undesired heat of each cell, effective packaging characteristics, structural integrity and improved heat absorption thereby eliminating problems associated with current designs of prior art battery packs having cooling systems.

### SUMMARY OF THE INVENTION

A battery unit or pack includes a plurality of trays mechanically connected to one another and positioned on top of one another to define sides and a top and a bottom of the battery unit. Each of the trays presents a peripheral edge surrounding the respective tray to define opposite side ends and terminal ends extending between a central axis and opposite dishes of the tray. The tray defines a plurality of spaced openings extending along the central axis. The openings may include a circular configuration or a rectangular configuration. The peripheral edge defines a plurality of slots at the terminal ends.

A plurality of cells are adjacent and connected with one another in overlapping relationship with each of the cells extending over the spaced openings. Preferably, the cells are lithium cells. Other cells may be utilized with the present invention without limiting the scope of the invention. Each of the cells has a first current collector and at least one first electrode, i.e cathode, being adjacent the first current collector and a second current collector and at least one second electrode, i.e. anode of charge opposite from the first electrode and adjacent the second current collector. A separator layer is positioned between the first and second electrodes for conducting electrolyte therebetween. The first and second electrodes, the separator are encapsulated by a shell or envelope. A controller (the LEC) is connected to the tray. The LEC operably communicates with each of the cells on each tray. Communications from each LEC are daisy chained down to a master controller connected to a bottom support tray. The bottom tray houses other components of the battery unit including and not limited to contactors, current sensors, pre-charge circuit, and connectors.

A cooling system of the battery pack is defined by a plurality of fins or baffles integral with and extending outwardly from one of the opposite dished of each of the trays. The fins are spaced by the central axis and extend in angular fashion relative to one another and the central axis. The fins form at least one of diverging or converging channels for reducing a flow of air injected from one of the terminal ends of each tray as the flow of air extends in diverging or converging fashions along the central axis and each of the fins thereby removing heat from each cell before the flow of air exits the battery pack thereby maintaining a pre-determined temperature inside the battery pack.

An advantage of the present invention is to provide a battery pack having efficient packaging characteristics, structural integrity and improved heat absorption and transfer characteristics thereby eliminating problems associated with current designs of prior art battery packs.

Another advantage of the present invention is to provide a battery pack having a balanced air management cooling system wherein each cell of the battery pack receives a similar temperature and flow of inlet air to assist removing the undesired heat.

Still another advantage of the present invention is to provide a battery pack that reduces manufacturing costs due to simplified assembly pattern. Still another advantage of the present invention is to provide a cooling system which allows the battery pack to deliver and receive high and fast rates of current, i.e. the C-rate, without producing heat during the rapid charge or discharge pulse that may negatively impact the performance and life span of the battery pack. Still another advantage of the present invention is to provide a pack that is simple in design and has a reduced weigh.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a battery pack of the present invention having a plurality of trays with battery cells connected thereto;

FIG. 2 is a perspective view of the tray, as viewed from the bottom of the tray, showing fins of a cooling system; and

FIG. 3 is another perspective view of the tray of FIG. 2, as viewed from the top, showing a plurality of the battery cells connected with one another in an overlapping fashion and operably communicated with a controller connected to the tray.

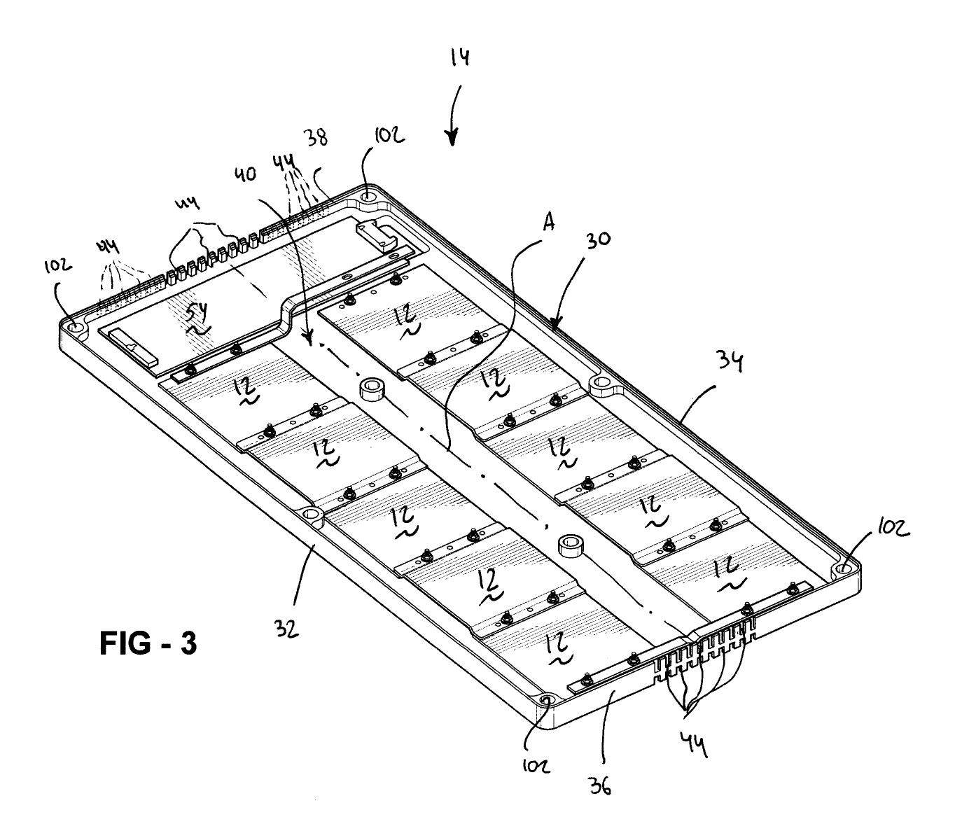

### DETAILED DESCRIPTION OF THE PREFERRED EMBODIMENT

Referring to the Figures, wherein like numerals indicate like or corresponding parts, a battery pack or unit of the present invention is generally shown at 10. The battery pack 10 of the present invention is adaptable to be utilized in various configurations including and not limited to an overlapping battery cell packaging configuration and a vertical stack battery cell packaging configuration used in an automotive vehicle applications. Various cells are utilized with the present inventive concept. Preferably, lithium cells (the cells or cell) 12 are used with the present invention. Those skilled in the lithium battery art will appreciate the components of the lithium cell 12 including and not limited to at least one first electrode or anode is adjacent a first current collector and at least one second electrode, i.e cathode of charge opposite from the first electrode is adjacent a second current collector. A separator layer is positioned between the first and second electrodes with the first and second electrodes conducting electrolyte therebetween. These aforementioned components are encapsulated by a shell or an envelope. Other cells (not shown) may be utilized by the present invention without limiting the scope of the present invention.

The battery pack 10 includes a plurality of trays 14 connected to one another and positioned on top of one another to define sides, generally indicated at 16 and 18 and terminal ends, generally indicated at 20 and 22, a top 24 and a bottom 26, all generally indicated in the respective fashion. Each of the trays 14 presents a peripheral edge or rim, generally indicated at 30, surrounding the respective tray 14 to define opposite side ends generally indicated at 32 and 34 and terminal ends, generally indicated at 36 and 38 extending between a central axis A and opposite dishes, generally indicated at 40 and 42 of the tray 14 as the peripheral rim 30 extends outwardly from the tray 14, as viewed in a cross section.

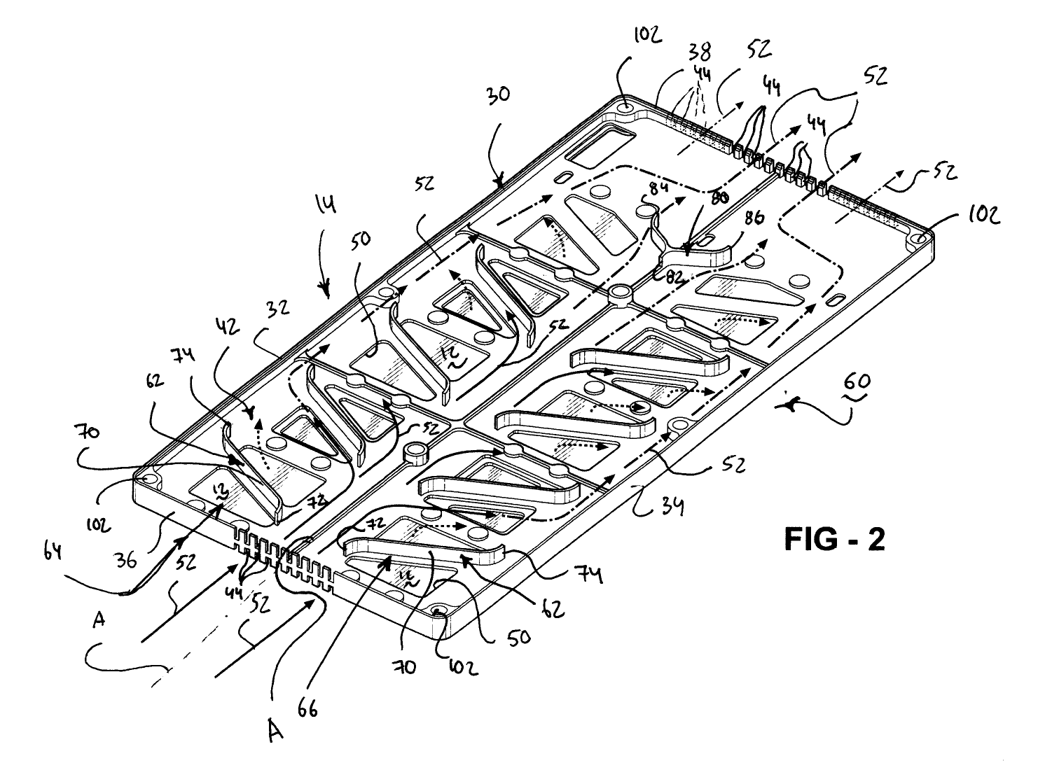

A plurality of slots or key ways 44 are formed at the peripheral rim 30 at each of the terminal ends 36 and 38. The slots 44 may extend along the entire terminal end 38, as shown in phantom in FIG. 2. A plurality of openings (only one is numbered at 50 in FIG. 2) are formed in each tray 14 to expose the cells 14 to a flow of fluid and/or air 52 for affecting temperature of the cells 14. The openings 50 may present a rectangular configuration or a circular configuration without limiting the scope of the present invention. The openings 50 extending along the central axis A. The flow of fluid and/or air 52 may the flow of cool air and/or fluid or hot air and/or fluid or combination thereof without limiting the scope of the present invention to significantly eliminate temperature variances, which occur from one cell 14 to the adjacent cell 14, thereby preventing detrimental impact on the performance and life span of the battery unit 10.

As best shown in FIG. 2, the cells 12 are adjacent one and the other and connected with one another in overlapping relationship. Each of the cells 12 extends over the spaced openings 50, as best shown in FIG. 2. A controller 54 (the LEC) is connected to each of the tray 14 and operably communicates with each of the cells 12. Each LEC 54 is communicated with a master controller (not shown). The operative connection of the LEC 54, assigned to the Applicant of the present invention and incorporated herewith in its entirety.

Alluding to the above and as best illustrated in FIG. 2, a temperature control system of the battery pack 10 is illustrated at 60 in FIG. 2. The system 60 is designed for both cooling and heating the cells 12. The system 60 is defined by a plurality of fins, only tow are generally indicated at 62, or buffles being integral with and extending outwardly from one of the opposite dishes of each of the trays 14. Alternatively, the fins 62 are mechanically connected to the opposite dishes (not shown) to be removed and replaced and re-arranged thereby controlling and changing direction of the flow of air. The shape and structure of the fins 62, as shown herein, is not intended to limit the scope of the present invention. The fins 62 are spaced by the central axis A and extend in angular fashion relative to one another and the central axis A.

Alluding to the above, the fins 62 are further divided into at least two rows, generally indicated at 64 and 66 separated by the central axis A. The fins 62 define a fluid passage for funneling fluid introduced from one terminal end 36 towards the other terminal end 38 and forcing fluid outwardly to the side walls 32, 34 and to the other terminal end 38 as fluid is funneled into the unit 10 thereby uniformly affecting the temperature of the cells 12. The funneling may be oriented in a converging fashion or diverging fashion (only one embodiment is shown in FIG. 2). The fins 62 arranged into the two rows 64 and 66 separated by the central axis A mirror imaging one another.

As best shown in FIG. 2, each fin 62 presents a flat central portion 70 terminating into inner end 72 and outer end 74 with each the inner ends 72 facing one of the terminal ends 36 of the unit 10 and the outer ends 74 facing the other of the terminal ends 38 of the unit 10. The inner ends 72 and the outer ends 74 regulating flow of fluid as fluid is forced from one of the terminal ends 36 along the central axis A of each tray 14 and outwardly from the central axis A to the side walls 32, 34 and along the side walls 32, 34.

Alluding to the above, ss the fins 62 of the rows 64 and 64 extend from one terminal end 36 to another terminal end 38, the distance between the inner ends 72 is decreased thereby forming a diverging channel, for reducing the flow of fluid 52 injected from one of the terminal ends 36 of each tray 14 as the flow of fluid 52 divergently extends along the central axis A and each of the fins 62 thereby removing heat from each cell 12 before the flow of fluid 52 exits the battery pack 10 thereby maintaining a pre-determined temperature inside the battery unit 10.

The flow of fluid or air 52 extends through the diverging channel, between each fin 62 of the rows 64 and 66 and then along the side ends 32, 34 and of each tray 14 directed by the outer end 74 of each fin 62. A V-shaped fin 80 has a peak 82 and spaced extremities 84 and 86 and is disposed adjacent the terminal end 30 of the tray 14 to effectively cool or heat the last row of the cells 12 before the flow of fluid 52 takes heat away from the battery pack 10. The peak 82 is positioned on the central axis A.

The battery pack 10 includes at least one inlet fan 90 connected to one of the sides 22 of the battery unit 10 for forcing the flow of fluid into each of the trays 14 trough the slots 44 of one of the terminal end 38. The battery unit 10 also includes at least one outlet fan 92 connected to another side 20 of the battery unit 10 for forcing the flow of unit 10 out of each of the trays 14 trough the slots 44 of another terminal end 38.

High voltage battery unit 10 of the present invention delivers and receive high and/or fast rates of current (C-rate). The problem is that in exchange for the high C-rate capability, the battery unit 10 produces heat during this rapid charge or discharge pulse. The purpose of this invention is to provide a balanced air management cooling system, such that each cell 12 receives a similar temperature and the flow of air to assist in removing the undesired heat.

As the flow of cool air 52 enters the battery unit 10 through an inlet port defined by the slots 44 of each tray 14 on the front side 14 of the battery pack 10. The flow of cool air 52 is forced through the central axis A of the battery unit 10 and progressively diverted via the angled fins 62 on the left and right side of the central axis A that force the flow of cool air over each individual cell 12 to remove the undesired or extra heat. The heated air from each cell 12 is then directed by the fins 62 into a common manifold (not shown) located at the extreme left and right sides of the battery unit 10. The heated air streams from both the left and the right side of the battery unit 10 are merged together at the rear and center of the battery unit 10 and exit at the exhaust port defined by the slots at the terminal ends 38 of each tray 14. The design layout of the air flow fins 62 is critical to provide a balance air flow over each cell 12 to balance heat removal. The fins 62 are designed to equally split the main stream of cool air and direct it equally over each cell 12. This is accomplished by progressively splitting the main stream multiple times.

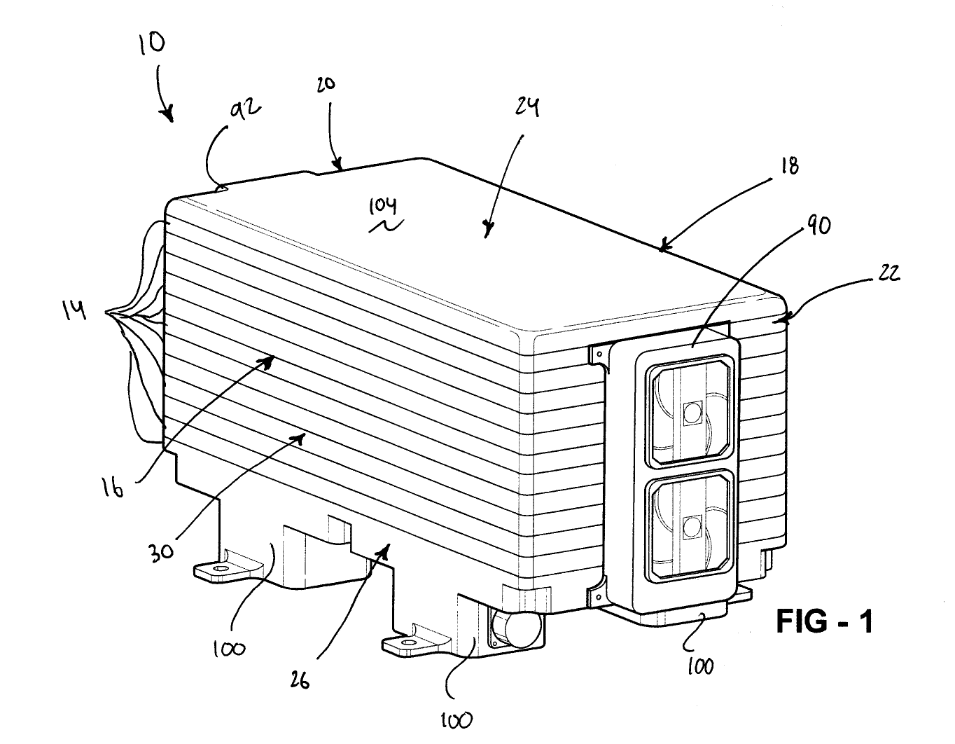

One of the trays 14 defines a bottom of the battery unit 10 and includes at least one boss section 100 or extension integral with and extending therefrom to connect the battery unit 10 to a surface, such as a vehicle body (not shown). Each tray 14 includes a plurality of peripheral openings 102 transversely extending therethrough to receive a mechanical connector or rod (not shown) to linearly interconnect each tray 14 with one another to form the battery pack 10, as illustrated in FIG. 1. A cover 104 is attached to the top tray 14 of the battery unit 10 to prevent penetration of debris, fluids, dust, or the like inside the battery pack and to provide structural integrity to the battery pack 10.

Alternatively, the battery unit 10 may include a frame (not shown) having multitude of channels defined therein to receive the trays 14 slidably removable therefrom to be replaced and/or serviced. The frame may have solid walls or a plurality of interconnected vertical and horizontal members with the peripheral edge of each of the trays forms the walls of the battery pack 10. The trays 14 are injection molded from a polymeric material. The trays 14 may be formed from a non-polymeric material. The material and methods of forming the trays 14 are not intended to limit the scope of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A temperature control device for a battery pack having a plurality of cells, said temperature control device comprising:
a plurality of surfaces for supporting the cells positioned thereon with said surfaces removably connected to one another and positioned on top of one another to form a unit having terminal ends and side walls;
a device connected to at least one of said terminal ends for introducing fluid through at least one of said surfaces of said unit for affecting the temperature of the cells; and
a plurality of members extending outwardly from at least one of said surfaces to define a fluid passage for funneling fluid introduced from one of said terminal ends towards the other terminal end and forcing fluid outwardly to said side walls and to the other terminal end thereby uniformly affecting the temperature of the cells.

2. A temperature control device as said forth in claims 1 wherein each of said surfaces presents a tray defining a central axis separating said tray into opposite halves, said tray presenting a first side and a second side with said first sides and said second sides of each tray defining said side walls of said unit.

3. A temperature control device as set forth in claim 2 wherein said plurality of members are further defined by fins arranged into two rows separated by said central axis and mirror imaging one another.

4. A temperature control device as set forth in claim 2 wherein each fin is angled relative said side walls and said terminal ends.

5. A temperature control device as set forth in claim 2 wherein each fin presents a flat central portion terminating into inner end and outer end with each said inner ends facing one of said terminal ends of said unit and said outer ends facing the other of said terminal ends of said unit with said inner ends and said outer ends regulating flow of fluid as fluid is forced from one of said terminal ends along said central axis of each tray and outwardly from said central axis to said side walls and along said side walls.

6. A temperature control device as set forth in claim 5 wherein said first side and said second side of each tray are further defined by a peripheral rim surrounding each of said trays thereby defining a first dish with said first side and a second dish with said second side with said trays mechanically connected to one another.

7. A temperature control device as set forth in claim 6 wherein said tray defines a plurality of openings extending between said terminal ends with the cells partially exposed through said openings to receive fluid.

8. A temperature control device as set forth in claim 6 wherein said peripheral rim includes a plurality of slots at each of said terminal end for circulating fluid through said unit.

9. A temperature control device as set forth in claim 6 wherein said device for introducing fluid is further defined by at least one fan.

10. A temperature control device as set forth in claim 9 including a bottom tray and a cover to encapsulate said unit.

11. A temperature control device as set forth in claim 10 wherein said trays, said bottom tray and said cover are injection molded from polymeric material.

12. A temperature control device as set forth in claim 1 wherein said fluid passage funnels fluid in at least one of converging and diverging modes.

13. A method of forming a temperature control device for a battery pack having a plurality of cells, said method comprising the steps of:
removably connecting a plurality of surfaces with one another to support the cells positioned thereon to form a unit having terminal ends and side walls;
connecting a device to at least one of the terminal ends to introduce fluid through at least one of the surfaces thereby affecting the temperature of the cells; and
forming a plurality of members extending outwardly from at least one of the surfaces to define a fluid passage to funnel fluid introduced from one of the terminal ends towards the other terminal end and to force fluid outwardly to the side walls thereby uniformly affecting the temperature of the cells.

14. A method as said forth in claim 13 wherein the step of removably connecting a plurality of surfaces is further defined by interconnecting a plurality of trays each defining a central axis separating the respective tray into opposite halves to present a first side and a second side.

15. A method as set forth in claim 13 wherein the step of forming a plurality of members is further defined by forming a plurality of fins arranged into two rows separated by the central axis and mirror imaging one another.

16. A method as set forth in claim 13 wherein the step of forming a plurality of fins is further defined by forming each fin in an angled fashion relative the side walls and the terminal ends.

17. A method as set forth in claim 13 wherein the step of forming a plurality of fins is further defined by forming each fin with a flat central portion terminating into inner end and outer end with each inner ends to face one of the terminal ends of the unit and the outer ends to face the other of the terminal ends of the unit with the inner ends and the outer ends regulating flow of fluid as fluid is forced from one of the terminal ends along the central axis of each tray and outwardly from the central axis to the side walls and along the side walls.

18. A method as set forth in claim 13 wherein the step of forming a plurality of fins is further defined by the step of forming a peripheral rim to surround each of the trays to define a first dish with the first side and a second dish with the second side.

19. A method as set forth in claim 13 including the step of forming a plurality of opening in each tray to extend the openings between the terminal ends to partially expose the cells through the openings to receive fluid.

20. A method as set forth in claim 13 including the step of forming a plurality of slots in the peripheral rim at each of the terminal ends to circulate fluid through the unit.

21. A method as set forth in claim 13 wherein the step of connecting a device to at least one of the terminal ends is further defined by connecting at least one fan to introduce fluid into the unit and at least fan to exhaust fluid out from the unit.

22. A method as set forth in claim 13 including the step of connecting a bottom tray and a cover to encapsulate the unit.

23. A method as set forth in claim 13 including the step of injection molding the trays, the bottom tray and the cover from polymeric material.

24. A temperature control device for a battery pack having a plurality of cells, said temperature control device comprising:
a plurality of trays for supporting the cells positioned thereon with said trays removably connected to one another and positioned on top of one another to form a unit having terminal ends and side walls;
each of said trays defining a central axis separating said tray into opposite halves, said tray presenting a first side and a second side with said first sides and said second sides of each tray defining said side walls of said unit; said first side and said second side of each tray are further defined by a peripheral rim surrounding each of said trays thereby defining a first dish with said first side and a second dish with said second side;
said peripheral rim including a plurality of slots at each of said terminal end for circulating fluid through said unit;
said trays being mechanically connected to one another wherein said tray defines a plurality of openings extending between said terminal ends with the cells partially exposed through said openings to receive fluid;
a plurality of fins extending outwardly from at least one of said first and second sides to define a fluid passage for funneling fluid introduced from one of said terminal ends towards the other terminal end and forcing fluid said terminal end outwardly to said side walls and to the other terminal end as fluid is funneled into said unit thereby uniformly affecting the temperature of the cells;
said fins arranged into two rows separated by said central axis and mirror imaging one another with each said fin being angled relative said side walls and said terminal ends;
said fins presenting a flat central portion terminating into inner end and outer end with each said inner ends facing one of said terminal ends of said unit and said outer ends facing the other of said terminal ends of said unit with said inner ends and said outer ends regulating flow of fluid as fluid is forced from one of said terminal ends along said central axis of each tray and outwardly from said central axis to said side walls and along said side walls;
said fins being arranged for funneling fluid in at least one of converging and diverging fashions;
at least one inlet fan connected to one of said terminal ends of said unit for forcing fluid into each of said trays trough said slots defined in said peripheral rim of each of said trays;
at least one outlet fan connected to another of said terminal ends of said trays for forcing the flow of fluid of each away from each said trays trough said slots defined in said peripheral rim at another of said terminal ends thereby affecting the temperature of the cells; and
a bottom tray and a cover to encapsulate said unit, wherein said trays, said bottom tray and said cover are injection molded from polymeric material.

25. A temperature control device for a battery pack having a plurality of cells plurality of cells are adjacent and connected with one another in overlapping relationship with each of the cells having at least one first electrode and at least one second electrode of charge opposite from the first electrode and a separator positioned between the first and second electrodes for conducting electrolyte therebetween, said temperature control device comprising:
a plurality of trays for supporting the cells positioned thereon with said trays removably connected to one another and positioned on top of one another to form a unit having terminal ends and side walls; and
a plurality of fins extending outwardly from at least one of said trays to define a fluid passage for injecting fluid introduced from one of said terminal ends towards the other terminal end in at least one of converging and diverging modes and forcing fluid outwardly to said side walls and to the other terminal end thereby uniformly affecting the temperature of the cells.

26. A temperature control device as set forth in claim 25 including at least one inlet fan connected to one of said terminal ends of said unit for forcing fluid into each of said trays trough said slots defined in said peripheral rim of each of said trays.

27. A temperature control device as set forth in claim 26 including at least one outlet fan connected to another of said terminal ends of said trays for forcing the flow of fluid of each away from each said trays trough said slots defined in said peripheral rim at another of said terminal ends thereby affecting the temperature of the cells.

28. A temperature control device as said forth in claims 25 wherein each of said trays defines a central axis separating said tray into opposite halves, said tray presenting a first side and a second side with said first sides and said second sides of each tray defining said side walls of said unit, said fins being arranged into two rows separated by said central axis and mirror imaging one another, each fin being angled relative said side walls and said terminal ends.

29. A temperature control device as set forth in claim 25 wherein each fin presents a flat central portion terminating into inner end and outer end with each said inner ends facing one of said terminal ends of said unit and said outer ends facing the other of said terminal ends of said unit with said inner ends and said outer ends regulating flow of fluid as fluid is forced from one of said terminal ends along said central axis of each tray and outwardly from said central axis to said side walls and along said side walls.

30. A temperature control device as set forth in claim 25 wherein said tray defines a plurality of openings extending between said terminal ends with the cells partially exposed through said openings to receive fluid.

31. A temperature control device as set forth in claim 25 including a controller connected to said tray operably communicating with each of the cells.
